(19) United States
(12) Patent Application Publication
(10) Pub. No.: US 2026/0356596 A1
(43) Pub. Date: Nov. 12, 2026

(54) METHOD AND SYSTEM FOR AUTOMATED DETECTION OF CONVEYOR BELT DAMAGE

(71) Applicant: Aleksei Gennadevich PRIDOROZHNYI, Moscow (RU)

(72) Inventor: Aleksei Gennadevich PRIDOROZHNYI, Moscow (RU)

(21) Appl. No.: 19/130,550

(22) PCT Filed: Apr. 24, 2023
(86) PCT No.: PCT/RU2023/000121

§ 371 Date: May 16, 2025

(30) Foreign Application Priority Data
Feb. 20, 2023 (RU) 2023103875

(51) Int. Cl. B65G 43/02; G05B 19/042

(52) U.S. Cl. CPC B65G 43/02; G05B 19/042

(57) ABSTRACT

This technical solution relates to the field of computer technologies, specifically to a method and system for automated detection of conveyor belt damage. The technical result lies in improving the accuracy of detecting conveyor belt damage by analyzing and processing thermal image frames of the belt surface and video images of the belt surface. The technical result is achieved through a method for the automated detection of conveyor belt damage, performed with the help of a computing device connected to at least one infrared camera and one video camera, and comprising the following steps:
a) obtaining a sequence of frames from at least one infrared and one video camera positioned in such a way as to capture thermal and video images of the conveyor belt surface;
b) obtaining data on the maximum temperature (Tₘₐₓ) and base temperature (T_{base}) of the conveyor belt surface for the obtained thermal image frames;
c) processing the obtained thermal image frames, during which the maximum temperature on the thermal image frame (Tₘₐₓ) is analyzed against the base surface temperature (T_{base}), checking for an exceedance by more than a set temperature window value (Δₜₑₘₚ) over a set time window (Δₜᵢₘₑ);
d) determining the presence of damage to the conveyor belt if, during the set time window (Δₜᵢₘₑ), an exceedance of Tₘₐₓ over T_{base} by more than the set temperature window (Δₜₑₘₚ) is observed in the thermal image frames;
e) storing the identified damage data in the memory of the computing device and/or transmitting it to an external device.

### TECHNICAL FIELD

The present technical solution relates to computer technologies, specifically to a method and system for the automated detection of conveyor belt damage.

### BACKGROUND OF THE INVENTION

In many industries, such as mining, processing, energy, chemical, cargo handling, and others, conveyor transportation is used for transporting bulk materials. Bulk materials, whether waste rock, ore, coal, coke, charge, concentrate, agglomerate, pellets, chemicals, or other substances, are transported directly on a conveyor belt from the loading area (typically near the tail pulley) to the unloading area (typically near the head/drive pulley). During the operation of the conveyor, emergency situations may arise due to conveyor belt damage, including the most severe damage—a longitudinal tear (cut) in the belt, which leads to partial or complete loss of the belt and unplanned downtime of the conveyor system for repair or belt replacement.

Longitudinal conveyor belt tears can be caused by a variety of factors:
The introduction of foreign materials that contaminate the transported material, such as an excavator tooth, scrap, rebar, steel sheet, etc. These objects can puncture the conveyor belt at the loading point, jam it, and cause a longitudinal tear;
Heavy, large, and sharp pieces of ore that can also puncture the belt, jam it, and cause a longitudinal tear;
Sharp elements from failed rollers, cleaning scrapers, idlers, or other parts of the conveyor, which can puncture and longitudinally cut the belt.

The quicker the emergency situation on the conveyor is localized and detected for stopping, the less conveyor belt will be lost as a result of damage.

The most widely used systems for protecting conveyor belts from longitudinal tears work on the principle of detecting damage to elements vulcanized into the belt (inductive loops, inserts, antennas, etc.). An example of such a system is the CONTI RipProtect system produced by Continental® (https://www.continental-industry.com/en/solutions/conveyor-belt-systems/conveyor-services/belt-monitoring/products/conti-protect/conti-ripprotect). Inductive loops are vulcanized into the belt at a certain pitch, as determined by the customer (usually 50-150 meters), so that when any of the inductive loops is damaged by a tear in the belt, the conveyor stops. In this case, the amount of damaged belt is limited by the installation pitch of the inductive loops in the conveyor belt.

The disadvantages of such a solution are that these systems cannot be used on all belts, as a belt with inductive loops is required, and inductive loops often fail, leading to false signals.

Laser systems are known, for example, CONTI SurfaceProtect (https://www.continental-industry.com/en/solutions/conveyor-belt-systems/convevor-services/belt-monitoring/products/conti-protect/conti-surfaceprotect), which use laser scanning of the belt surface to detect damage, including longitudinal belt tears.

The main disadvantages of these systems are that they are highly sensitive to environmental conditions, positioning, and the state of the belt surface (problems arise when the belt surface is wet or when transported material sticks to the surface, filling the damaged areas), leading to very strict operational requirements for these systems and a large number of false activations.

Systems are known that monitor the width of the belt (http://www.beltscan.com/products/belt-guard-5k-fabric-belt-rip-detector.html) or determine its integrity by transmitting vibration across the belt (http://www.beltscan.com/products/belt-guard-10k-rip-detector-for-steel-cord-belts.html). The principle of operation of systems based on monitoring the belt width is that, as a result of a longitudinal tear, the belt may either separate or narrow due to the torn parts overlapping, resulting in a change in its width. To determine the belt's width, ultrasonic or radar sensors are used to monitor the edges of the belt. The principle of operation of systems based on vibration transmission across the belt is that, in the case of a longitudinal tear, the integrity of the belt is disrupted, and vibration does not transmit across the belt.

The main disadvantages of systems that monitor the belt width are that if, in the case of a tear, the belt does not separate or narrow, the tear is not detected, as the belt width does not change. Vibrational systems are very sensitive to the type of belt carcass and rubber compound and are not applicable to all types of belts. Moreover, in the case of a longitudinal tear, the signal can effectively bypass the conveyor belt through the transported material, thus not detecting the longitudinal tear.

### SUMMARY

The proposed solution aims to overcome the shortcomings of the known approaches from the prior art and provides a new method and system for efficient automated monitoring of the conveyor belt condition.

The technical result consists in improving the accuracy of detecting conveyor belt damage by analyzing and processing thermal images of the belt surface and video images of the belt surface.

The efficiency of the proposed system in enhancing the accuracy of detecting conveyor belt damage is ensured by the fact that any mechanical damage to the conveyor belt, including a longitudinal tear, is inevitably accompanied by the release of thermal energy and an increase in temperature on the belt surface. This is reflected in the thermal images and is additionally verified by capturing the belt surface using a video camera.

The technical result is achieved through a method for automated detection of conveyor belt damage, performed using a computing device connected to at least one infrared camera and one video camera, and comprising the following steps:
a) Obtaining a sequence of frames from at least one infrared camera and one video camera, arranged in such a way as to capture thermal and video images of the conveyor belt surface;
b) Obtaining data on the maximum temperature Tₘₐₓ and the base temperature T_{base} of the conveyor belt surface for the obtained thermal image frames;
c) Processing the obtained thermal image frames, during which the maximum temperature Tₘₐₓ of the belt surface in the thermal image is analyzed for exceeding the base temperature T_{base} by more than a predetermined temperature window value Δₜₑₘₚ within a specified time window Δₜᵢₘₑ;
d) Determining the presence of conveyor belt damage if, during the specified time window Δ_time, the maximum temperature Tₘₐₓ on the thermal image frames exceeds the base temperature T_{base} by more than the predetermined temperature window value Δₜₑₘₚ;
e) Storing the data about detected damage in the memory of the computing device and/or transmitting them to an external device.

In one particular embodiment of the method, the computing device is additionally connected to a thermometer that measures the ambient temperature T_{ambient}.

In another particular embodiment of the method, at step b), T_{base} is determined based on T_{ambient}, or as the minimum temperature of the belt surface in the thermal image frame, or it is set using the computing device.

In another particular embodiment of the method, at step c), the time window Δₜᵢₘₑ is a sequence of a specified number of consecutive thermal image frames.

In another particular embodiment of the method, at step c), the fact that the maximum temperature on the thermal image frame Tₘₐₓ exceeds T_{base} by more than the predetermined temperature window value Δ_temp is confirmed if the temperature of a specified number of pixels in the thermal image frame also exceeds T_{base} by more than Δₜₑₘₚ.

In another particular embodiment of the method, the pixels are adjacent.

In another particular embodiment of the method, at step c), the time window Δₜᵢₘₑ is counted from the first detected thermal image frame where the maximum temperature Tₘₐₓ exceeds T_{base} by more than the predetermined temperature window value Δₜₑₘₚ.

In another particular embodiment of the method, at step c), the degree of continuity R of the temperature Tₘₐₓ exceeding T_{base} by more than the predetermined temperature window value Δₜₑₘₚ within the specified time window Δₜᵢₘₑ is determined, where parameter R is defined as the specified number of frames or the percentage of frames recorded during Δₜᵢₘₑ for which Tₘₐₓ exceeds T_{base} by more than the predetermined temperature window value Δₜₑₘₚ.

In another particular embodiment of the method, at step d), the fact that Tₘₐₓ exceeds T_{base} by more than the predetermined temperature window value Δₜₑₘₚ within the specified time window Δₜᵢₘₑ is determined by the achievement of a critical value of parameter R.

In another particular embodiment of the method, the section of the conveyor where the infrared camera is located contains protective walls.

In another particular embodiment of the method, the external surface of the walls has a light or heat-reflective coating.

In another particular embodiment of the method, the infrared camera and/or video camera is installed in a housing with a heating function.

In another particular embodiment of the method, the computing device is configured to recognize characteristic patterns of conveyor belt damage by analyzing images from the infrared camera and/or video camera using analytical methods or artificial neural networks.

In another particular embodiment of the method, the external device is connected to the computing device via a wired or wireless data transmission channel.

In another particular embodiment of the method, the external device is one of the following: a monitor, an interactive screen, a computer, a laptop, a tablet, a smartphone, a smart wearable device, a removable data carrier, a conveyor belt control controller, or a remote conveyor belt control system.

In another particular embodiment of the method, the computing device is connected to the conveyor belt control system by one of the following methods: through relay outputs, Modbus protocol, or Profibus or Profinet networks.

In another particular embodiment of the method, the computing device generates a signal to stop the conveyor belt, which is transmitted to the conveyor belt control system upon detecting damage to the conveyor belt.

In another particular embodiment of the method, the video image from the video camera is synchronized with the thermographic image from the infrared camera.

In another particular embodiment of the method, the computing device processes the video images and thermograms obtained from the video and infrared cameras and creates an augmented reality display in the graphical user interface (GUI) by overlaying the thermogram or areas on the video image where the temperature is higher than the base surface temperature T_{base} by more than the predetermined temperature window value Δₜₑₘₚ.

In another particular embodiment of the method, the GUI is implemented on the external device and/or in the computing device.

In another particular embodiment of the method, the GUI includes the ability to set a ROI (Region of Interest) that characterizes the area of interest in the video image and/or thermogram, in which data analysis is performed.

In another particular embodiment of the method, the external device is additionally configured to set up the computing device and/or track the result of the analysis of the conveyor belt condition performed by the computing device.

In another particular embodiment of the method, the computing device additionally generates an emergency signal to notify the conveyor operator about the presence of damage to the conveyor belt, which is transmitted to the external device and/or an audio and/or visual alarm device.

The claimed technical result is also achieved through the implementation of a system for automated detection of conveyor belt damage, comprising a computing device connected to at least one infrared and one video camera, positioned in such a way as to receive thermal and video images of the surface of the conveyor belt, where the computing device ensures:
obtaining a sequence of frames from at least one infrared and one video camera, positioned to capture thermal and video images of the conveyor belt surface;
obtaining data on the maximum Tₘₐₓ and base T_{base} temperatures of the conveyor belt surface for the obtained thermal image frames;
processing the obtained thermal image frames, during which the maximum temperature on the thermal image frame Tₘₐₓ is analyzed against the base surface temperature T_{base}, checking if it exceeds the given temperature window value Δₜₑₘₚ within the set time window Δₜᵢₘₑ;
determining the presence of damage to the conveyor belt if frames of the thermal image show that Tₘₐₓ exceeds T_{base} by more than the given value of the temperature window Δₜₑₘₚ during the set time window Δₜᵢₘₑ;
storing the data on the identified damage in memory and/or transmitting it to an external device.

In one particular embodiment of the system, the computing device is additionally connected to a thermometer that measures the ambient temperature T_{ambient}.

In another particular embodiment of the system, at the stage of determining T_{base}, it is defined based on T_{ambient}, or as the minimum surface temperature of the belt on the thermal image frame, or is set using the computing device.

In another particular embodiment of the system, the time window Δₜᵢₘₑ is a sequence of a specified number of consecutive thermal image frames.

In another particular embodiment of the system, the fact of exceeding the maximum temperature on the thermal image frame Tₘₐₓ above T_{base} by more than the specified temperature window value Δₜₑₘₚ is confirmed if the temperature of a specified number of pixels on this thermal image frame also exceeds T_{base} by more than Δₜₑₘₚ.

In another particular embodiment of the system, the pixels are adjacent.

In another particular embodiment of the system, the time window Δₜᵢₘₑ is counted from the first detected thermal image frame where the maximum temperature Tₘₐₓ exceeds T_{base} by more than the specified temperature window value Δₜₑₘₚ.

In another particular embodiment of the system, the computing device determines the continuity degree R of the exceeding of Tₘₐₓ over T_{base} by more than the specified temperature window value Δₜₑₘₚ during the set time window Δₜᵢₘₑ, where the parameter R is defined as the specified number of frames or the percentage of frames recorded during Δₜᵢₘₑ, for which Tₘₐₓ exceeds T_{base} by more than the specified temperature window value Δₜₑₘₚ.

In another particular embodiment of the system, the fact of exceeding Tₘₐₓ over T_{base} by more than the specified temperature window value Δₜₑₘₚ during the set time window Δₜᵢₘₑ is determined when the parameter R reaches the specified critical value.

In another particular embodiment of the system, the section of the conveyor where the infrared camera is located contains protective barriers.

In another particular embodiment of the system, the outer surface of the barriers contains a light- or heat-reflective coating.

In another particular embodiment of the system, the infrared camera and/or video camera is installed in a housing with a heating function.

In another particular embodiment of the system, the computing device is configured to recognize characteristic patterns of conveyor belt damage when analyzing images from the infrared camera and/or video camera using analytical methods or an artificial neural network.

In another particular embodiment of the system, the external device is connected to the computing device via a wired or wireless data transmission channel.

In another particular embodiment of the system, the external device is one of the following: a monitor, an interactive screen, a computer, a laptop, a tablet, a smartphone, a smart wearable device, a removable data carrier, a conveyor control controller, or a remote conveyor control system.

In another particular embodiment of the system, the computing device is connected to the conveyor control system by one of the following methods: through relay outputs, via the Modbus protocol, or through Profibus or Profinet networks.

In another particular embodiment of the system, the computing device generates a signal to stop the conveyor belt, which is transmitted to the conveyor control system when a belt damage is detected.

In another particular embodiment of the system, the video image from the video camera is synchronized with the thermogram image from the infrared camera.

In another particular embodiment of the system, the computing device processes video images and thermograms obtained during the filming from the video and infrared cameras and creates an augmented reality display in the graphical user interface (GUI) by overlaying the thermogram or areas with temperatures higher than the base temperature of the belt surface T_{base} by more than the specified temperature window value Δₜₑₘₚ onto the video image.

In another particular embodiment of the system, the GUI is implemented on an external device and/or in the computing device.

In another particular embodiment of the system, the GUI includes the ability to set a Region Of Interest (ROI), which characterizes the area of interest in the video image and/or thermogram where the data analysis takes place.

In another particular embodiment of the system, the external device is additionally configured to allow the configuration of the computing device and/or to monitor the results of the conveyor belt condition analysis performed by the computing device.

In another particular embodiment of the system, the computing device additionally generates an emergency signal to notify the conveyor belt operator of the presence of conveyor belt damage, which is transmitted to the external device and/or to an audio and/or visual notification device.

### BRIEF DESCRIPTION OF THE DRAWINGS

FIG. 1 shows the general view of the claimed system.

FIG. 2 shows the block diagram of the method for detecting conveyor belt damage.

FIGS. 3A-3B show examples of thermal images obtained during conveyor belt monitoring.

FIG. 3C shows an example of generating damage data for the belt using augmented reality technology.

FIG. 4 shows an example of a diagram analyzing temperature readings in thermal image frames.

FIG. 5 shows the general view of the computing device.

### DETAILED DESCRIPTION OF THE INVENTION

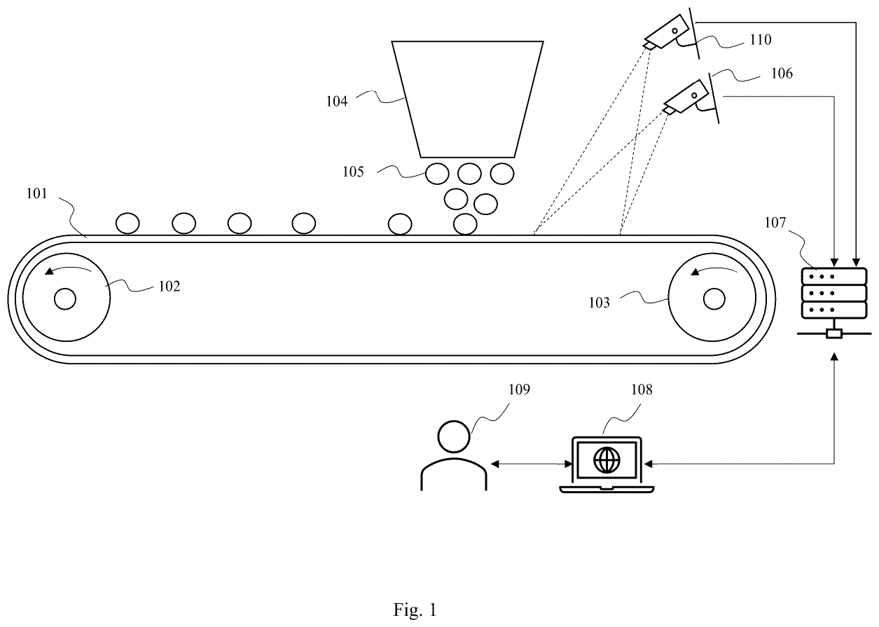

As shown in FIG. 1, the solution involves the creation of an automated method for monitoring the condition of a conveyor belt (101) during the transportation of material (105), particularly ores, rocks, and other types of material fed onto the belt (101) through a loading hopper (104). The movement of the conveyor belt (101) is achieved by rotating the head (driving) (102) and tail (103) drums, and there may be multiple driving drums. These drums are powered by electric motors, which, in turn, are activated by a control controller (not shown).

The analysis of the conveyor belt (101) condition is carried out using an infrared camera (IR-camera) (106) and a video camera (110), which are positioned in such a way as to capture images of the belt's surface. Preferably, the cameras (106, 110) are positioned such that their control areas are synchronized. These cameras (106, 110) can be installed either below or above the return section of the belt (101) to capture the working or non-working surface of the belt (101), below the carrying section of the belt (101) to capture the non-working surface of the belt (101), or before the loading hopper (104), ensuring the capture of either the working or non-working surface of the belt (101).

The placement of the IR camera (106) and the video camera (110) is determined by the specific structural design of the conveyor and the allowable installation positions for the cameras (106, 110) at certain points on the conveyor, in such a way as to ensure the capture of the belt's (101) surface for obtaining objective data for subsequent analysis. It should be noted that the examples of camera placements (106, 110) provided do not limit other potential placements on the conveyor, nor do they exclude the use of multiple cameras of the same or different types.

The video camera (110) provides a supplementary video stream alongside the thermal image from the IR camera (106). The obtained video images of the belt (101) allow for additional detection and identification of areas with damage to the belt (101).

The IR camera (106) and the video camera (110) are connected to the computing device (107), for example, a stationary PC, server, or computing module (block), such as one based on a CPU (one or more processors), microcontroller, etc. The computing device (107) can be installed directly on the conveyor or connected to it via a data transmission channel. The computing device (107) can also be implemented in a single housing with one of the cameras (106, 110) or with both types of cameras simultaneously. The device (107) performs the necessary computational processes when analyzing the frames of thermal images from the IR camera (106) and the video stream from the video camera (110), performing subsequent processing to detect the occurrence of damage to the conveyor belt (101). The connection of the IR camera (106) and video camera (110) to the computing device (107) can be made using well-known communication principles, in particular, through wired or wireless connections, such as USB, Wi-Fi, TCP/IP, etc. The cameras (106, 110) can be PTZ-type cameras, allowing remote control. The computing device (107) may archive the video recording from the video camera (110) and the thermal image recordings from the IR camera (106) as well as the processing results in memory.

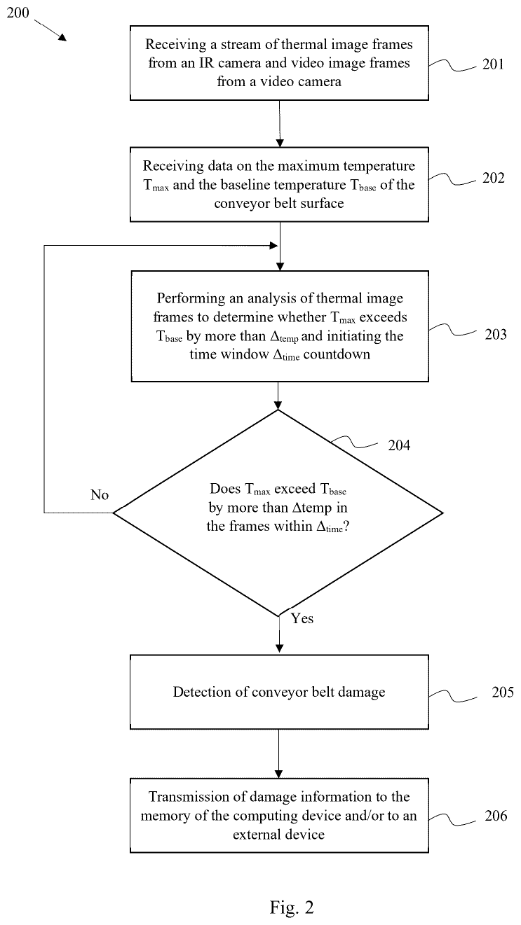

FIG. 2 shows the step-by-step process of the automated conveyor belt state monitoring method (200). In step (201), the computing device (107) receives a stream of thermal image frames from the IR camera (106) as well as video frames from the camera (110) that capture images of the surface of the belt (101). The data from the cameras (106, 110) is transmitted via a data transmission channel. A thermal image frame from the IR camera (106) represents a thermogram that captures the temperature of objects within the IR camera's (106) field of view. The video camera (110) captures an image of the surface of the belt (101), which allows for later synchronization of the video data and the thermogram. Based on the obtained thermal image frames, in step (202), the base temperature T_{base} of the conveyor belt (101) surface and the maximum temperature Tₘₐₓ of the conveyor belt (101) surface are determined by processing the data with the device (107).

The base temperature, T_{base}, is the minimum temperature on the surface of the operating conveyor belt (101), which does not significantly change and is generally close in value to the ambient temperature in which the conveyor belt operates. This is because, under normal operating conditions, the surface of the conveyor belt (101) usually does not heat up, and the conveyor belt (101) itself is in thermodynamic equilibrium with the surrounding environment. The value of T_{base} can be obtained either from the direct analysis of the incoming thermal image from the IR camera (106) (the minimum temperature on the thermogram) or from additional means connected to the device (107), such as a thermometer (in particular, an electronic thermometer) that detects the ambient temperature T_{ambient} in which the conveyor belt (101) operates. Additionally, the value of T_{base} may represent a pre-set value entered into the computational logic of the computing device (107) or determined by the device using a combination of the above methods.

Tₘₐₓ is the maximum temperature on the belt surface (101) in a thermal image frame, determined by the temperature of the pixel with the highest temperature on the thermogram.

In step (203), the thermal image frames are analyzed for any Tₘₐₓ exceeding T_{base}. If, in step (203), a thermal image frame is found where Tₘₐₓ exceeds T_{base} by more than a given value of the temperature window Δₜₑₘₚ (which defines the critical temperature difference indicating potential damage to the conveyor belt), the counting of the time window Δₜᵢₘₑ begins from this frame. The time window Δₜᵢₘₑ may represent not only a specific time interval but also a sequence of a set number of consecutive thermal image frames (for example, 2, 3, 5, 10, 15 frames, etc.).

In step (204), the thermal image frames that fall within the specified time window Δₜᵢₘₑ are analyzed, and the magnitude of the exceedance of Tₘₐₓ over T_{base} is determined. The magnitude of the Tₘₐₓ exceedance over T_{base} in the analyzed frames is compared with the specified value of the temperature window Δₜₑₘₚ.

If, at step (204), the thermal image frames in the specified time window Δₜᵢₘₑ (for example, 3, 5, 10, 20 seconds, etc.) or during a sequence of a specific number of consecutive frames (for example, 2, 3, 5, 10, 15 frames, etc.), the Tₘₐₓ exceeds T_{base} by more than the given value of the temperature window Δₜₑₘₚ (for example, by 10 °C, 20 °C, 50 °C, 100 °C, etc.), this indicates the occurrence of damage to the conveyor belt (101), which is recorded at step (205). As a result, at step (206), a data packet about the belt damage is generated and stored on the computing device (107).

If, however, the check at step (204) shows that Tₘₐₓ exceeds T_{base} by less than the given value of the temperature window Δₜₑₘₚ during the analysis of thermal image frames within the specified time window Δₜᵢₘₑ, no damage to the belt (101) is recorded, and the device's (107) operational algorithm continues analyzing the incoming thermal image frames until the next frame is found with Tₘₐₓ exceeding T_{base} by more than Δₜₑₘₚ.

At steps (203) and (204), to avoid false triggers, an additional pixel analysis may be applied to the received thermal image frames. In this case, the fact that the temperature in the thermal image frame exceeds T_{base} by more than the specified value of the temperature window Δₜₑₘₚ is confirmed if the temperature of a specified number of pixels on the frame also exceeds T_{base} by more than Δₜₑₘₚ. These pixels will be considered “hot,” as their recorded temperature exceeds T_{base} by more than Δₜₑₘₚ.

Such “hot” pixels may be analyzed on the thermal image to determine their relative positioning to each other. This helps reduce the chance of false triggers when identifying belt damage. Specifically, these pixels should be adjacent to each other, positioned next to one another, regardless of their proximity type (horizontal, vertical, or diagonal). The adjacency of pixels, in particular, is determined by their placement in neighboring cells of the IR camera's (106) pixel matrix.

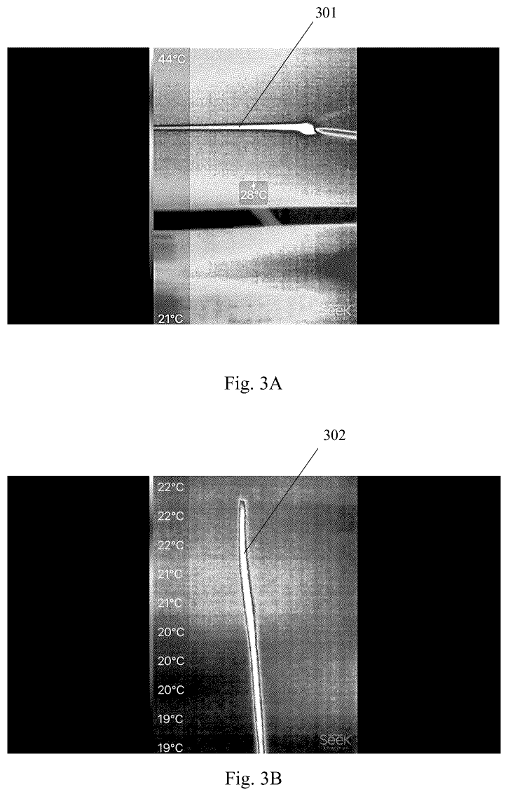

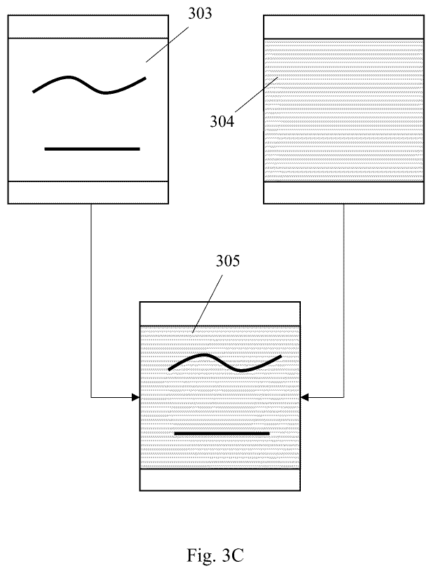

FIGS. 3A-3B show examples of areas on the conveyor belt (101) surface associated with increased temperatures indicating damage, in particular, areas on frames (301, 302) show an infrared trace from a cut in the belt. When the belt (101) is cut by foreign material or a sharp piece of ore, a large amount of thermal energy is released. Since the energy of the conveyor drive station is spent on deformation, destruction, and friction in the cut area, most of the energy required for cutting the belt (101) is released as heat, leading to the heating of the conveyor belt in the cut area. The heat release is so intense that it can cause the temperature in the cut area to rise by tens of degrees. A longitudinal cut appears as a line, making it effectively detectable in the infrared spectrum, as it represents a bright line of higher temperature (Tₘₐₓ) compared to the base temperature (T_{base}) of the belt, indicating the cut.

FIG. 3C shows an example of forming an augmented reality image (305) in the graphical user interface (GUI), generated by the computing device (107) by overlaying the thermal image (303) from the infrared camera (106) onto the video image (304) recorded by the video camera (110). Additionally, instead of the thermal image (303), areas where the temperature exceeds the base surface temperature T_{base} by more than the specified temperature window Δₜₑₘₚ can be overlaid onto the video image, with these areas highlighted, for example, by color filling.

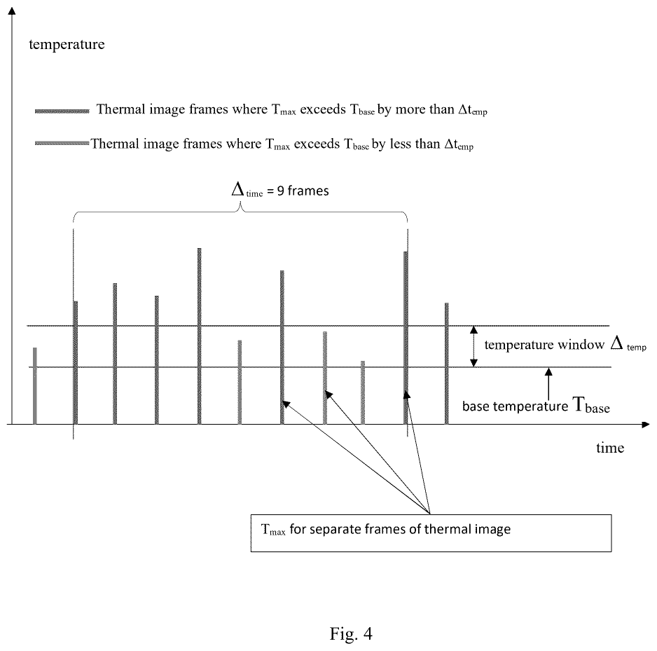

As shown in FIG. 4, in one of the specific embodiments of the proposed solution, in order to improve the accuracy of detecting belt (101) damage, a continuity degree parameter R can be used to measure the extent of Tₘₐₓ exceeding T_{base} by more than the specified temperature window Δₜₑₘₚ over a specified time window Δₜᵢₘₑ. The parameter R is defined as the number or percentage of frames, recorded within Δₜᵢₘₑ, where Tₘₐₓ exceeds T_{base} by more than the specified temperature window Δₜₑₘₚ. The time window Δₜᵢₘₑ can represent a sequence of a specified number of consecutive frames, for example, 9, 10, 15 frames, etc. (as shown in FIG. 4, Δₜᵢₘₑ is represented by 9 frames), during which the exceeding of Tₘₐₓ over T_{base} by more than the specified Δₜₑₘₚ is analyzed.

In this case, at step (204), the fact of exceeding Tₘₐₓ over T_{base} by more than the specified temperature window Δₜₑₘₚ within the specified time window Δₜᵢₘₑ is determined by the parameter R reaching a critical value R_{critical}. This allows for more sensitive detection of temperature changes on the surface of the belt (101) and the identification of belt damage, even if for some reason, in certain frames within the Δₜᵢₘₑ window, the exceeding of Tₘₐₓ over T_{base} by more than the specified temperature window Δₜₑₘₚ is not observed. The critical value R_{critical} can have various values (20%, 25%, 30%, 42%, 50%, 80%, etc., or 3, 5, 10, 30 frames, etc.), depending on the method used to define the continuity degree parameter R, and is set based on the conveyor belt's speed, operating conditions, required damage detection sensitivity, type of damage, number of IR cameras installed, parameters set in device (107), etc. As shown in the example of FIG. 4, the continuity degree R is 6/9≈67%, meaning that 67% of frames or 6 frames detect the exceeding of Tₘₐₓ over T_{base} by more than the specified temperature window Δₜₑₘₚ. If, for example, the critical value R_{critical} is set at 50% or 5 frames, since R has reached or exceeded R_{critical}, the fact of damage to the belt is recorded.

Based on the collected data on the characteristic damages of the conveyor belt (101), the computing device (107) can also enable the creation of damage patterns (e.g., a pattern library) for subsequent recognition using analytical methods or artificial neural networks. These networks will be trained on the aforementioned damage patterns of the belt (101) for their rapid identification.

Additionally, the proposed solution can include an external device (108) that can be operated by a user (109), such as a conveyor operator, and is intended to receive real-time information about the condition of the conveyor belt (101). The device (108) may generally represent a PC, tablet, laptop, smartphone, smart wearable device, or a removable data storage medium or conveyor control unit, or a remote conveyor control system. In this case, the computing device (107) may include the function of programming and remotely setting its operating parameters via the external device (108), such as through a web interface (web browser) or a software application.

Furthermore, the computing device (107) can be connected to the conveyor control system in one of the following ways: via relay outputs, using the Modbus protocol, or through Profibus or Profinet networks. In this case, when the device (107) detects a belt (101) damage, it can generate a signal to stop the conveyor, which is transmitted from the device (107) to the conveyor control system and/or other external devices.

The external device (108), as well as the device (107), can interact with the user via a graphical user interface (GUI), which may include the function of specifying areas for analysis. The analysis can be carried out by setting (indicating) the ROI (Region of Interest), which represents the area of interest in the video image and/or thermal image, where the data analysis takes place.

In one particular implementation of the solution, the device (107) may generate an additional signal alerting about the damage to the belt (101), which is sent to a signaling device (such as a light or sound signal), the conveyor operator's control panel, or other external devices (108), for example, in the form of notifications (SMS, PUSH, e-mail), via a relay connection, or another control signal over Ethernet or Wi-Fi, and displayed in the graphical interface of the device (108).

The proposed solution can be applied in conveyor operation in both hot and cold climates. To reduce the impact of the surrounding temperature on the accuracy of the thermal image frames from the IR camera (106), the section of the conveyor where the IR camera (106) is located is equipped with protective walls. These walls can be covered with light- or heat-reflecting coatings to prevent external weather and temperature factors from affecting the accuracy of the IR camera's (106) operation. In cold climate conditions, to prevent failure of the IR camera (106) and video camera (110), each of the cameras (106, 110) may be installed in a special casing equipped with a heating function.

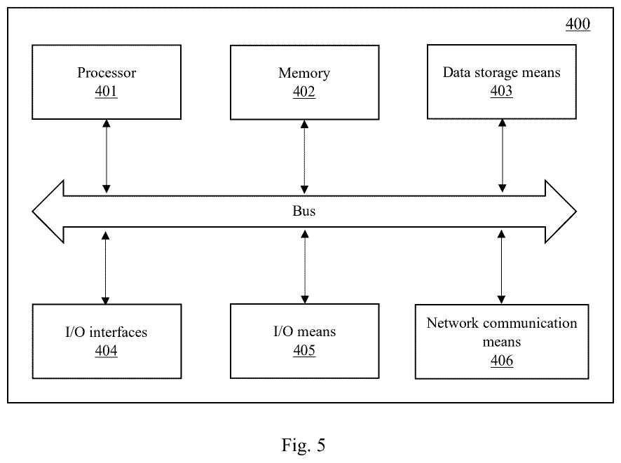

FIG. 5 shows an example of a general computing device (400), such as a computing unit (module), computer, server, laptop, smartphone, SoC (System-on-a-Chip), etc., which can be used for the full or partial implementation of the proposed solution, particularly for implementing devices (107, 108). In general, device (400) contains the following components: one or more processors (401), at least one RAM (402), a permanent data storage medium (403), input/output interfaces (404), including relay outputs for connecting to conveyor movement controllers, I/O means (405), and network communication means (406).

The processor (401) of the device performs the main computational operations necessary for the functioning of the device (400) or the functionality of one or more of its components. The processor (401) executes the required machine-readable commands stored in the RAM (402).

The memory (402) is typically implemented as RAM and contains the necessary software logic that provides the required functionality. The data storage medium (403) can be implemented as HDD, SSD disks, RAID arrays, network storage, flash memory, optical data storage (CD, DVD, MD, Blue-Ray disks), etc. Medium (403) allows long-term storage of various types of information, such as query processing history (logs), user identifiers, camera data, images, etc.

The interfaces (404) are standard means for connecting and interacting with computing devices. The interfaces (404) can include, for example, relay connections, USB, RS232/422/485 or other connections, RJ45, LPT, UART, COM, HDMI, PS/2, Lightning, Fire Wire, etc., and can also operate with protocols such as Modbus and networks like Profinet. The choice of interfaces (404) depends on the specific implementation of the device (400), which could be a computing block (module) based on a CPU (one or more processors), a microcontroller, a personal computer, a mainframe, a server cluster, a thin client, a smartphone, a laptop, etc., as well as external devices that may be connected.

As input/output devices (405), the following can be used: a keyboard, joystick, display (touchscreen), projector, touchpad, mouse, trackball, light pen, speakers, microphone, etc.

The network interaction means (406) are chosen from devices that ensure network data reception and transmission, such as an Ethernet card, WLAN/Wi-Fi module, Bluetooth module, BLE module, NFC module, IrDa, RFID module, GSM modem, etc. Using device (406), data exchange can be organized over wired or wireless transmission channels such as WAN, PAN, LAN, Intranet, Internet, WLAN, WMAN, GSM, quantum data channels, satellite communications, etc. The components of device (400) are typically connected via a common data bus.

The present application has disclosed a preferred embodiment of the claimed technical solution, which should not be construed as limiting other, specific embodiments of its implementation that do not fall outside the scope of the requested legal protection and are apparent to specialists in the relevant field of technology.

1. A method for automated detection of conveyor belt damage, carried out using a computing device connected to at least one infrared camera and one video camera, and comprising the following stages:
a) a sequence of frames is obtained from at least one infrared and one video camera, positioned in such a way as to capture thermal and video images of the conveyor belt surface;
b) data about the maximum temperature Tₘₐₓ and the baseline temperature T_{base} of the conveyor belt surface are obtained for the captured thermal image frames;
c) the captured thermal image frames are processed, during which the maximum temperature on the thermal image frame of the conveyor belt surface Tₘₐₓ is compared with the baseline temperature T_{base} of the belt surface, and during process checks if Tₘₐₓ exceeds T_{base} by more than a predetermined temperature window value Δₜₑₘₚ over a specified time window Δₜᵢₘₑ;
d) the presence of damage to the conveyor belt is determined if the Tₘₐₓ exceeds T_{base} by more than the predetermined value of Δₜₑₘₚ on the thermal image frames during the specified time window Δₜᵢₘₑ;
e) data about the identified damage is recorded in the memory of the computing device and/or transmitted to an external device.

2. The method of claim 1, wherein the computing device is additionally connected to a thermometer that measures the ambient temperature T_{ambient}.

3. The method of claim 2, wherein at stage b) the T_{base} is determined based on T_{ambient}, or as the minimum temperature of the belt surface in the thermal image frame, or is set using the computing device.

4. The method of claim 1, wherein at stage c) the time window Δₜᵢₘₑ represents a sequence of a predetermined number of consecutive thermal image frames.

5. The method of claim 1, wherein at stage c) the fact that the maximum temperature on the thermal image frame Tₘₐₓ exceeds the baseline temperature T_{base} by more than the predetermined temperature window Δₜₑₘₚ is confirmed if the temperature of a specified number of pixels on the thermal image frame also exceeds T_{base} by more than Δₜₑₘₚ.

6. The method of claim 5, wherein the pixels are adjacent.

7. The method of claim 1, wherein at stage c) the time window Δₜᵢₘₑ is measured from the first identified thermal image frame where Tₘₐₓ exceeds T_{base} by more than the predetermined value of Δₜₑₘₚ.

8. The method of claim 1, wherein at stage c) the degree of continuity R of the maximum temperature Tₘₐₓ exceeding the baseline temperature T_{base} by more than the predetermined value of the temperature window Δₜₑₘₚ over the specified time window Δₜᵢₘₑ is determined, where the parameter R is defined as a specific number of frames or a percentage of frames captured during Δₜᵢₘₑ, for which Tₘₐₓ exceeds T_{base} by more than the predetermined value of Δₜₑₘₚ.

9. The method of claim 8, wherein at stage d) the fact that Tₘₐₓ exceeds T_{base} by more than the predetermined value of the temperature window Δₜₑₘₚ over the specified time window Δₜᵢₘₑ is determined by reaching a critical value of the parameter R.

10. (canceled)

11. (canceled)

12. (canceled)

13. The method of claim 1, wherein the computing device is configured to recognize characteristic damage patterns of the conveyor belt when analyzing images from the infrared camera and/or video camera using analytical methods or an artificial neural network.

14. (canceled)

15. (canceled)

16. (canceled)

17. (canceled)

18. (canceled)

19. (canceled)

20. (canceled)

21. (canceled)

22. (canceled)

23. The method of claim 1, wherein the computing device additionally generates an emergency signal to notify the conveyor operator of the presence of damage to the conveyor belt, which is transmitted to the external device and/or a sound and/or light signaling device.

24. A system for automated detection of conveyor belt damage, comprising a computing device connected to at least one infrared camera and one video camera, positioned in such a way as to capture thermal and video images of the conveyor belt surface, wherein the computing device ensures:
the acquisition of a sequence of frames from at least one infrared and one video camera, positioned to capture thermal and video images of the conveyor belt surface;
the acquisition of data on the maximum temperature Tₘₐₓ and base temperature T_{base} of the conveyor belt surface for the obtained thermal image frames;
the processing of the obtained thermal image frames, wherein the maximum temperature on the thermal image frame Tₘₐₓ is analyzed against the base temperature of the conveyor belt surface T_{base} to determine if it exceeds the set temperature window Δₜₑₘₚ within a given time window Δₜᵢₘₑ;
the determination of damage to the conveyor belt if, during the given time window Δₜᵢₘₑ, the temperature Tₘₐₓ exceeds the base temperature T_{base} by more than the set value of the temperature window Δₜₑₘₚ on the thermal image frames;
The storage of the data on identified damages and/or their transmission to an external device.

25. The system of claim 24, wherein the computing device is additionally connected to a thermometer that measures the ambient temperature T_{ambient}.

26. The system of claim 25, wherein at the stage of determining T_{base}, it is defined based on T_{ambient}, or as the minimum temperature of the belt surface in the thermal image frame, or is set using the computing device.

27. The system of claim 24, wherein the time window Δₜᵢₘₑ represents a sequence of a predetermined number of consecutive thermal image frames.

28. The system of claim 24, wherein the exceedance of the maximum temperature on the thermal image frame Tₘₐₓ over T_{base} by more than the set temperature window Δₜₑₘₚ is confirmed if the temperature of a specified number of pixels on this thermal image frame also exceeds T_{base} by more than Δₜₑₘₚ.

29. The system of claim 28, wherein the pixels are neighboring.

30. The system of claim 24, wherein at the stage, the time window Δₜᵢₘₑ is counted from the first detected thermal image frame where the exceedance of Tₘₐₓ over T_{base} is more than the set temperature window Δₜₑₘₚ.

31. The system of claim 24, wherein the computing device determines the degree of continuity R of the exceedance of Tₘₐₓ over T_{base} by more than the set temperature window Δₜₑₘₚ during the given time window Δₜᵢₘₑ, where the parameter R is defined as a certain number of frames or the percentage of frames recorded during Δₜᵢₘₑ for which Tₘₐₓ exceeds T_{base} by more than the set temperature window Δₜₑₘₚ.

32. The system of claim 31, wherein the fact of exceedance of Tₘₐₓ over T_{base} by more than the set temperature window Δₜₑₘₚ during the given time window Δₜᵢₘₑ is determined by the parameter R reaching a set critical value.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)
